(19) United States
(12) Patent Application Publication
(10) Pub. No.: US 2026/0227009 A1
(43) Pub. Date: Aug. 6, 2026

(54) FIRESTOP DROP-IN AND UNDER-DECK DEVICES

(71) Applicant: RELIANCE WORLDWIDE CORPORATION, Atlanta, GA (US)

(72) Inventors: Ryan J. MILLER, La Mesa, CA (US); James W. COSLEY, Ramona, CA (US)

(21) Appl. No.: 19/152,399

(22) PCT Filed: Feb. 6, 2024
(86) PCT No.: PCT/US2024/014555

§ 371 Date: Jul. 30, 2025

Related U.S. Application Data
(60) Provisional application No. 63/483,451, filed on Feb. 6, 2023.

(51) Int. Cl. F16L 5/04

(52) U.S. Cl. CPC F16L 5/04

(57) ABSTRACT

Drop-in and under-deck firestop devices. A firestop device can include a sleeve structure. The sleeve structure can include a first part and a second part that are movable about a joint section between an opened position and a closed position. The sleeve structure can have an inner surface and opposite outer surface. The firestop device can include a first smoke-seal ring positioned on the outer surface of the sleeve structure, a first intumescent ring positioned below the first smoke-seal ring on the outer surface of the sleeve structure, a second smoke-seal ring positioned on the inner surface of the sleeve structure; and a second intumescent ring positioned below the second smoke-seal ring on the inner surface of the sleeve structure. The first and second smoke-seal rings and the first and second intumescent rings can be respectively adhered or otherwise secured to the inner and outer surfaces of the sleeve structure.

### PRIORITY CLAIM

This application claims benefit of co-pending U.S. Provisional Patent Application No. 63/483,451, filed Feb. 6, 2023, the disclosure of which is incorporated by reference in its entirety.

### TECHNICAL FIELD

The present disclosure relates generally to firestop devices commonly used in building structures; more particularly directed to drop-in and under-deck firestop devices for use with core drilled or pre-existing holes in concrete slabs during new construction or retrofitting and/or re-piping.

### BACKGROUND

Building regulations may require a listed firestop system be installed when rated assemblies within a building get penetrated or otherwise become compromised. These penetrations can take place through concrete structures, such as decks, slabs, walls, and floors. Items known as cast-in-place firestop devices involve the embedding of a tube and sealing materials in concrete as it is poured and hardens. Cast-in-place firestop sleeves can be used for newly poured concrete floors in multi-story buildings. However, cast-in-place firestop devices are not suitable when holes are needed to be firestopped in existing concrete floors, which are typically made by core-drilling, or when hollow sleeves are formed into the concrete floor slabs and thus lack built-in firestopping materials. Core-drilled holes can be made in cured concrete decks and firestopping may be performed at a later stage in construction. Core-drilling is often performed when a floor is built with corrugated metal decking and concrete, and the use of cast-in-place firestop devices is not always permitted. Cast-in-place firestop devices are also not suitable when an existing building is being retrofitted/re-piped and there are newly drilled and existing holes in the concrete deck that need to be firestopped.

There is a need for a more improved firestop device to provide the code required firestopping material through concrete structures and/or around pre-existing pipes, tubes, conduits, etc. already passing through a hole in the concrete structure that is easier to install. The present disclosure addresses these and other related and unrelated issues in the art.

### SUMMARY

The present disclosure relates to improved fire-stop devices. Specifically, the present disclosure relates to drop-in and under deck firestop devices that allow for firestopping of core-drilled, hollow sleeved, and existing holes in corrugated or flat concrete decks. Drop-in devices are designed for installation on a top side of a deck. Under-deck devices are designed for installation on a bottom side of a deck. Both drop-in and under deck devices according to the present disclosure include a cage or metal sleeve structure that can be moved between an opened position and a closed position. As such, the drop-in and under deck devices can be opened for internal assembly and closed for final assembly and installation via a joint section defined in the metal sleeve structure. The joint section may be centrally located in the metal sleeve structure and include one or more slits (i.e., openings, areas of weakening) that allow flexibility of the metal sleeve structure to move between the opened and closed positions. During installation, the metal sleeve structure of the drop-in and under deck devices can be configured to collapse and lock around a tube, pipe, or conduit running through an existing hole or passage in a concrete deck.

One aspect of the present disclosure relates to a firestop device that includes a metal sleeve structure with a plurality of smoke-seal and intumescent location features. The metal sleeve structure can have an inner surface and an opposite outer surface. The firestop device can include a first smoke-seal ring positioned on the inner surface of the metal sleeve structure, a first intumescent ring positioned below the first smoke-seal ring on the inner surface of the metal sleeve structure, a second smoke-seal ring positioned on the outer surface of the metal sleeve structure; and a second intumescent ring positioned below the second smoke-seal ring on the outer surface of the metal sleeve structure. The first and second smoke-seal rings and the first and second intumescent rings can be respectively located on and adhered or otherwise secured to the inner and outer surfaces of the metal sleeve structure using the plurality of location features. The first intumescent ring can be attached to the inner surface of the sleeve structure by bending attachment tabs located on the inner surface of the metal sleeve structure. The second intumescent ring and smoke-seal rings can be adhered to the inner and outer surfaces of the metal sleeve structure.

Another aspect of the present disclosure relates to a method of making a firestop device. The method includes a step of providing a metal sleeve structure. The metal sleeve structure can be movable between an open position and a closed position. The metal sleeve structure can have an inner surface and an outer surface. The metal sleeve structure can have a plurality of location features. When in the open position, the method includes a step of securing a first smoke-seal ring and a first intumescent ring to the inner surface of the metal sleeve structure. When in the closed position, the method includes a step of securing a second smoke-seal ring and a second intumescent ring to the outer surface of the metal sleeve structure. The method includes a step of retaining the first and second smoke-seal rings and the first and second intumescent rings to the respective inner and outer surfaces of the metal sleeve structure by locating the first and second smoke-seal rings and the first and second intumescent rings of the metal sleeve structure using the plurality of location features and securing them to the metal sleeve structure by adhesion or by bending attachment tabs of the metal sleeve structure.

A further aspect of the present disclosure relates to a method of installing a firestop device. The method includes a step of providing a metal sleeve structure in an open position for assembly. The metal sleeve structure can have a first smoke-seal ring positioned on an inner surface thereof, a first intumescent ring positioned below the first smoke-seal ring on the inner surface, a second smoke-seal ring positioned on an outer surface of the metal sleeve structure, and a second intumescent ring positioned below the second smoke-seal ring on the outer surface of the metal sleeve structure. The method can include a step of moving the metal sleeve structure from the opened position to a closed position. The method can include a step of positioning the metal sleeve structure into a cylindrical, or near cylindrical, passage formed or cut into the concrete. The method can also include a step of rigidly fixing the metal sleeve structure in the closed position into the concrete opening/void. In certain examples, the metal sleeve structure is inserted from a top side of the concrete and rigidly fixed with support brackets. In other examples, the metal sleeve structure is inserted from a bottom side of the concrete and rigidly fixed with wing plates.

These and other features and advantages will be apparent from a reading of the following detailed description and a review of the associated drawings. A variety of additional aspects will be set forth in the description that follows. The aspects can relate to individual features and to combinations of features. It is to be understood that both the foregoing general description and the following detailed description are exemplary and explanatory only and are not restrictive of the broad concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates an exploded perspective view of an example drop-in firestop device including a cage, support brackets, intumescent rings, and smoke-seal rings in accordance with principles of the present disclosure.

FIG. 2 illustrates an assembled front view of the drop-in firestop device of FIG. 1.

FIG. 3 illustrates a cross-sectional view taken along line 3-3 of FIG. 2.

FIG. 4 illustrates a perspective view of the cage of FIG. 1 in an opened position showing an inner surface thereof.

FIG. 5 illustrates a perspective view of the cage of FIG. 4 in a closed position showing an outer surface thereof.

FIG. 6 illustrates a perspective view of the drop-in firestop device of FIG. 2.

FIG. 7 illustrates an enlarged view of a latch arrangement in accordance with the principles of the present disclosure.

FIG. 8 illustrates a top view of the drop-in firestop device of FIG. 6.

FIG. 9 illustrates an enlarged view of a portion of the support bracket of FIG. 6.

FIG. 10 illustrates a top view of the drop-in firestop device of FIG. 2 including a cover installed in a concrete structure by the support brackets in accordance with the principles of the present disclosure.

FIG. 11 illustrates a cross-sectional view taken along line 11-11 of FIG. 10.

FIG. 12 illustrates an enlarged view of a portion of FIG. 11.

FIG. 13 illustrates a top view of the drop-in firestop device of FIG. 6 showing a pipe installed through the concrete structure in accordance with the principles of the present disclosure.

FIG. 14 illustrates a cross-sectional view taken along line 14-14 of FIG. 13.

FIG. 15 illustrates an exploded perspective view of an under-deck firestop device showing wing plates in accordance with the principles of the present disclosure.

FIG. 16 illustrates an assembled top view of the under-deck firestop device of FIG. 15.

FIG. 17 illustrates a bottom view of the under-deck firestop device of FIG. 16.

FIG. 18 illustrates an enlarged view of a portion of FIG. 17.

FIG. 19 illustrates a side view of the under-deck firestop device of FIG. 16.

FIG. 20 illustrates a cross-sectional view taken along line 20-20 of FIG. 19.

FIG. 21 illustrates a bottom view of the under-deck firestop device mounted to a bottom concrete structure in accordance with the principles of the present disclosure.

FIG. 22 illustrates a cross-sectional view taken along line 22-22 of FIG. 21.

FIG. 23 illustrates an enlarged view of a portion of FIG. 22.

FIG. 24 illustrates a bottom view of the under-deck firestop device of FIG. 17 with a pipe installed through the opening in the concrete structure in accordance with the principles of the present disclosure.

FIG. 25 illustrates a cross-sectional view taken along line 25-25 of FIG. 24.

### DETAILED DESCRIPTION

The present disclosure relates to improved drop-in and under-deck firestop devices. The advantageous features of the drop-in and under-deck firestop devices allow for firestopping of core-drilled and existing holes in corrugated or flat concrete decks. The drop-in and under-deck firestop devices include a metal sleeve structure that can be moved between an opened position for internal assembly and a closed position for final assembly and installation.

When in an open configuration, inner surfaces of the metal sleeve structure may be exposed to adhere or otherwise secure smoke-seal and intumescent rings thereon. The metal sleeve structure can be moved to a closed, cylindrical configuration via a joint section defined in the metal sleeve structure. The joint section may be centrally located in the metal sleeve structure and include one or more slits (i.e., openings, areas of weakening) that allow flexibility of the metal sleeve structure to move between opened and closed positions.

When in the closed configuration, the metal sleeve structure may be configured to collapse and lock around a pipe, tube, or conduit running through an existing hole or be placed within a passage of a concrete deck prior to installing the pipe.

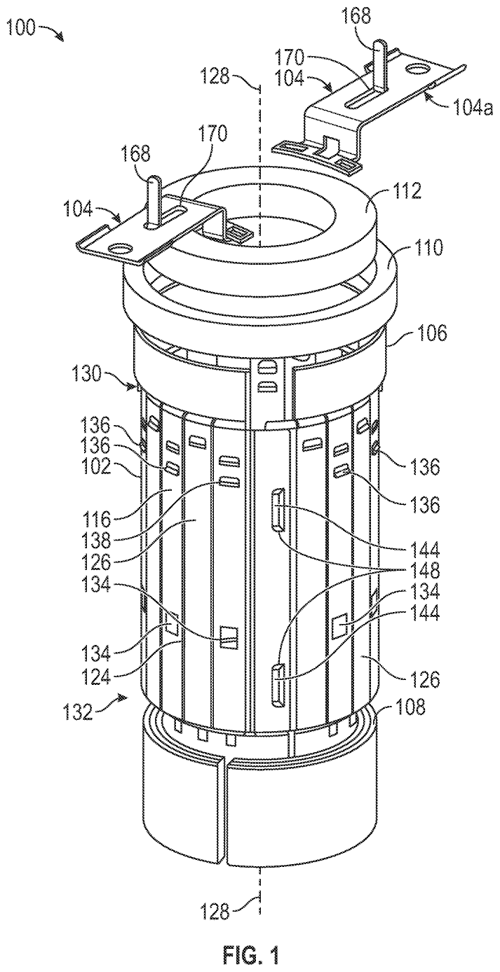

FIG. 1 illustrates an exploded view of an example drop-in firestop device 100 in accordance with principles of the present disclosure. The drop-in firestop device 100 includes a cage (e.g., sleeve structure) 102, support brackets 104, a first intumescent ring 106, a second intumescent ring 108, a first smoke-seal ring 110, and a second smoke-seal ring 112. The drop-in firestop device 100 is designed to meet fire rated standards per ASTM E814, ANSI/UL 1474, CAN ULC S115, or similar accepted industry fire rated standards.

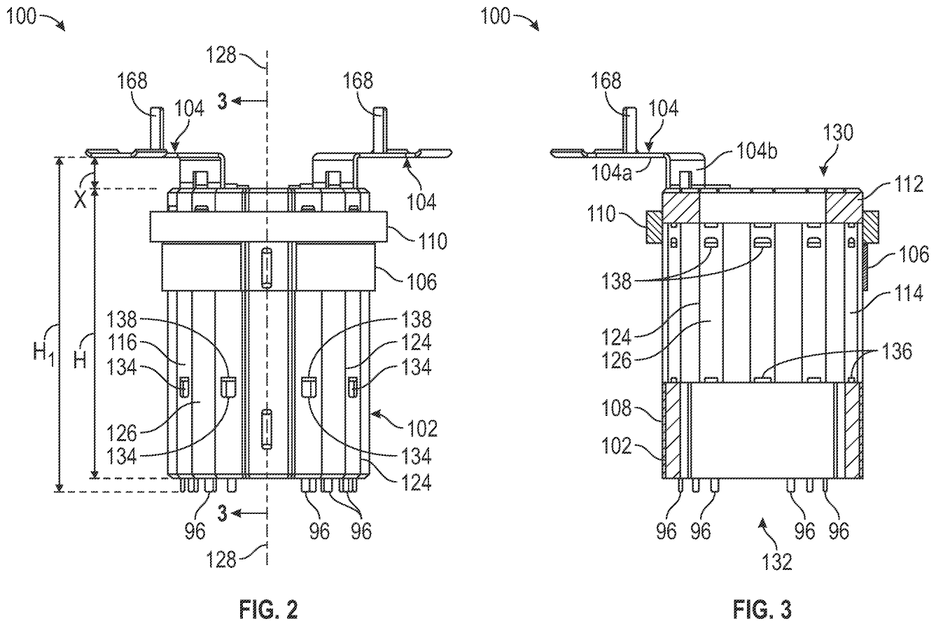

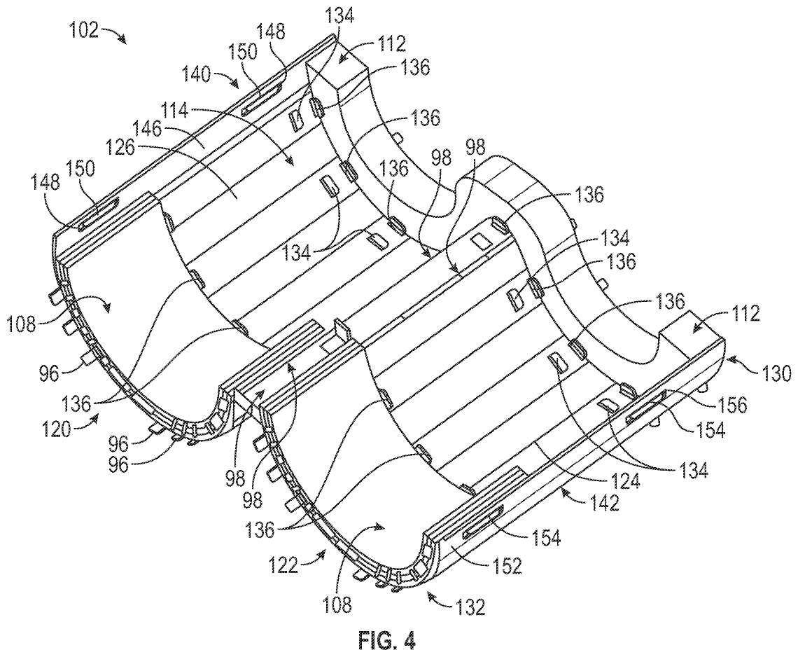

FIG. 2 shows the drop-in firestop device 100 assembled in a closed, rolled configuration. The cage 102 may be formed of a one-piece sheet metal construction by a stamping operation, although alternatives are possible. The sheet metal may include aluminum, corrosion resistant steel, galvanized metal or metal coated to resist corrosion. The cage 102 can be moved between an opened position and a closed position. The cage 102 has an inner surface 114 and an outer surface 116. The cage 102 may initially be configured in the opened position (see FIG. 4). The cage 102 can be configured in the opened position to provide full access to the inner surface 114 of the cage 102 for assembling the second intumescent ring 108 and the second smoke-seal ring 112 to the inner surface 114 prior to installation.

In certain examples, the cage 102 can be opened via a joint segment 98 centrally located in the cage 102. The joint segment 98 generally separates the cage 102 into a first part 120 (e.g., a first half, a first hemispherical section) and a second part 122 (e.g., a second half, a second hemispherical section). The joint segment 98 defines one or more slits 118 (i.e., openings, areas of weakening). The slits 118 may be intermittent cuts defined along opposing sides of the joint segment 98, although alternatives are possible. In certain examples, the slits 118 may be continuous. The slits 118 allow flexibility of the first part 120 of the cage and the second part 122 of the cage 102 to move between the opened and closed positions. That is, the first and second parts 120, 122 may be rotatable relative to each other between the open position and the closed position.

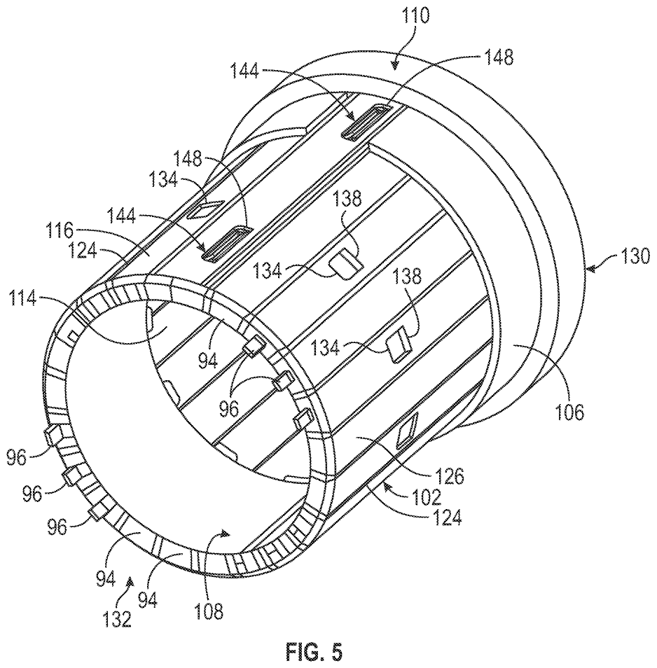

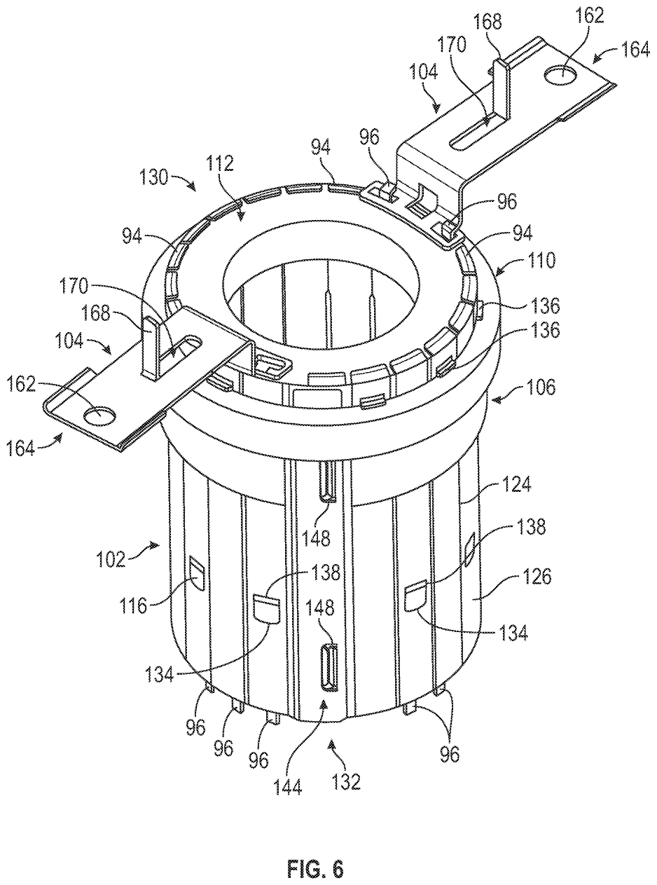

Referring to FIGS. 5-6, the cage 102 is shown in the closed position. The cage 102 is moved to the closed position for final assembly. The first intumescent ring 106 and the first smoke-seal ring 110 may be assembled to the outer surface 116 of the cage 102 while in the closed position, although alternatives are possible. In certain examples, the first intumescent ring 106 and the first smoke-seal ring 110 may be assembled to the outer surface 116 of the cage 102 while in the opened position.

In certain examples, the first and second intumescent rings 106, 108 and the first and second smoke-seal rings 110, 112 may be cut to length as desired prior to be being attached to the cage 102. It will be appreciated that the first and second intumescent rings 106, 108 and the first and second smoke-seal rings 110, 112 may each include split rings, respectively, with at least one split forming first and second adjacent ends.

In certain examples, the cage 102 may be scored to form score lines (e.g., fold lines) 124 that create adjacent, parallel segments 126 (e.g., sections). In other examples, the segments 126 may be created by a punching process. The plurality of sections 126 may be connected together at the score lines 124. The score lines 124 may function as a living hinge allowing the adjacent, parallel segments 126 of the cage 102 to bend along a length of the score lines 124 when moved between the opened and closed positions. The adjacent segments 126 may be rectangular in shape and have a height H (see FIG. 2) that extends along a longitudinal axis 128 of the drop-in firestop device 100 between a first side 130 (e.g., a top side, upper side) of the cage 102 and a second side 132 (e.g., a bottom side, lower side) of the cage 102.

Still referring to FIGS. 5-6, the cage 102 further defines a plurality of cutouts 134 or windows that can be stamped or punched through the metal sheet of the cage 102. When the metal sheet is punched, flaps or ring locating tabs 136 are created in the cage 102. The cutouts 134 each have an edge 138 that allow the flaps to extend outwardly therefrom toward either side of the cage 102. The ring locating tabs 136 of the cage 102 can be configured to bend for respectively retaining, securing, or locating the first and second intumescent rings 106, 108, and the first and second smoke-seal rings 110, 112 on the cage 102. For example, the ring locating tabs 136 can be stamped to bend and extend inwardly from the inner surface 114 of the cage 102 or outwardly from the outer surface 116 of the cage 102.

The ring locating tabs 136 can be configured to help position and secure the first and second intumescent rings 106, 108 and the first and second smoke-seal rings 110, 112 onto the inner or outer surfaces 114, 116 of the cage 102, respectively.

In certain examples, the first and second intumescent rings 106, 108 and the first and second smoke-seal rings 110, 112 may each have adhesive backs that may be adhered to the inner and outer surfaces 114, 116 of the cage 102, respectively.

The first smoke-seal ring 110 is shown on the outer surface 116 of the cage 102 adjacent the first side 130 thereof and above the first intumescent ring 106. The first intumescent ring 106 may be positioned below the first smoke-seal ring 110 about ¼ inch, although alternatives are possible. The first smoke-seal ring 110 may be an adhesive-backed foam made of closed cell, thermoplastic urethane (TPU) or other suitable material. The TPU material is compressible and compresses flat into or against a pipe when the first intumescent ring 106 expands during a fire. The first smoke-seal ring 110 may function as a smoke stop to provide a barrier to smoke/gas moving along the longitudinal axis 128 of the drop-in firestop device 100. The first smoke-seal ring 110 may also function as a heat collector to trigger the first intumescent ring 106 activity by trapping any heat generated from a fire. As such, the first smoke-seal ring 110 can provide an initial barrier to smoke and heat at lower temperatures prior to reaching the higher temperatures needed to activate the first intumescent ring 106.

The second intumescent ring 108 is mounted on the inner surface 114 adjacent the second end 132 of the cage 102. The second smoke-seal ring 112 is positioned above the second intumescent ring 108 adjacent the first end 130 of the cage 102. As such, the second intumescent ring 108 and the second smoke-seal ring 112 are positioned at opposing ends of the cage 102. The ring locating tabs 136 are positioned in the bent orientation to help position and secure the second smoke-seal ring 112 and second intumescent ring 108 on the cage 102. In certain examples, two separate lengths of the second intumescent ring 108 may be included. In other examples, up to 6 separate lengths of the second intumescent ring 108 may be used for use with six-inch firestop devices. The second intumescent ring 108 may be two millimeters thick, although alternatives are possible.

Still referring to FIGS. 5-6, the plurality of segments 126 may be configured to bend around the first and second sides 130, 132 of the cage 102 to form a plurality of mounting flanges 94 at the first and second sides 130, 132 of the cage 102. The mounting flanges 94 may be integrally formed with the segments 126, although alternative are possible. The score lines 124 may extend out to the first and second sides 130, 132 of the cage 102 to the mounting flanges 94. The score lines 124 may provide a living hinge for the mounting flanges 94 to allow flexibility therebetween when the cage 102 is moved between the opened and closed positions. The plurality of mounting flanges 94 may be configured to help secure the second intumescent ring 108 and the second smoke-seal ring 112 at the respective first and second sides 130, 132 of the cage 102. That is, the mounting flanges 94 may be bent at the first and second sides 130, 132 to extend perpendicularly to the longitudinal axis 128 to provide an end stop that helps to secure the second intumescent ring 108 and the second smoke-seal ring 112 at the respective first and second sides 130, 132 of the cage 102. In certain examples, the mounting flanges 94 may each have a projection 96 (e.g., tab portions). The projections 96 of the mounting flanges 94 may extend in a direction away from the respective first and second sides 130, 132 of the cage 102.

When the cage 102 is moved to the closed position, the first smoke-seal ring 110 will also be circular in shape around the outside of the cage 102 and encircle the longitudinal axis 128 of the drop-in firestop device 100. Locking the cage 102 in the closed position allows the ends of the first smoke-seal ring 110 to approach each other in a tangential or circumferential direction such that there is believed to be little or no gap between the ends.

Referring again to FIG. 4, the cage 102 has a first end 140 and an opposite, second end 142. The first end 140 may be defined by the first part 120 and the second end 142 may be defined by the second part 122, although alternatives are possible. When the cage 102 is moved from the opened position to the closed position, the first and second ends 140, 142 of the cage 102 can be joined together to form a cylindrical configuration. The first and second ends 140, 142 can be interconnected in a locking manner via latch arrangements 144 (see FIG. 1). The latch arrangements 144 of the drop-in firestop device 100 can be used to secure the cage 102 in the closed position.

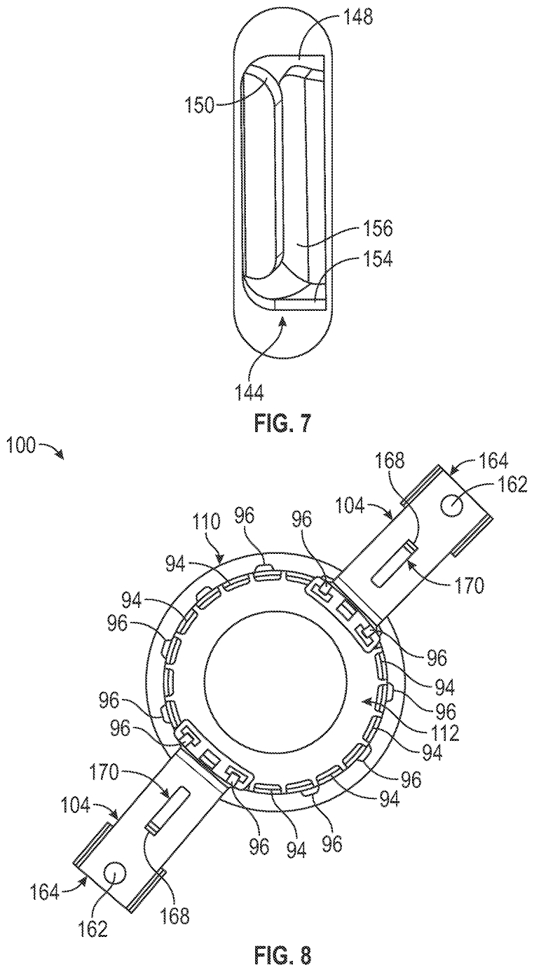

The cage 102 can include a first end segment 146 positioned at the first end 140 of the cage 102 and a second end segment 152 positioned at the second end 142 of the cage 102. The first end segment 146 of the cage 102 may define at least one tab opening 148 (e.g., cutout, receptacle) (see FIG. 4) through which a tab member 150 extends. In the example depicted, the first end segment 146 includes two tab openings 148, although alternatives are possible. The two tab openings 148 are positioned one above the other and each includes the tab member 150, although alternatives are possible. The second end segment 152 of the cage 102 may define at least one corresponding tab opening 154 (e.g., cutout, receptacle) with a tab member 156 (see FIG. 7). The tab openings 148, 154 and the tab members 150, 156 can be stamped or punched out of the sheet metal. As such, the tab members 150, 156 can be defined by a region of sheet metal within a perimeter consisting of the tab openings 148, 154. In the example depicted, the second end segment 152 includes two corresponding tab openings 154, although alternatives are possible. The two corresponding tab openings 154 are positioned one above the other with tab members 156, although alternatives are possible.

Although the cage 102 is depicted with four total tab openings with four tab members, in other examples (not shown) the cage 102 may include any other suitable number of tab openings and tab members. Also, although in the exemplary example the tab openings and tab members at each of the first and second ends 140, 142 are arranged in parallel with respect to each other along the longitudinal axis 128, in other examples some or all of the tab openings and tab members can be arranged asymmetrically or in any other suitable arrangement. It will be appreciated that other mechanical fasteners may be used to join the first and second ends 140, 142 of the cage 102 together.

When the cage 102 is in the closed position, the first and second ends 140, 142 of the cage 102 are joined together. As such, corresponding tab openings 154 and the tab members 156 located at the second end 142 of the cage 102 can align with the tab openings 148 and tab members 150 located at the first end 140 of the cage 102. The tab members 150 at the first end 140 of the cage 102 can be received and secured in the corresponding tab openings 154 at the second end 142 of the cage 102. The tab members 150, 156 together make an interfering lock mechanism that creates the latch arrangements 144 to lock the cage 102 in the closed position about the longitudinal axis 128. That is, the tab members 150, 156 can be designed to lock within the tab openings 148, 154 to hold the first and second ends 140, 142 of the cage 102 together in the closed position.

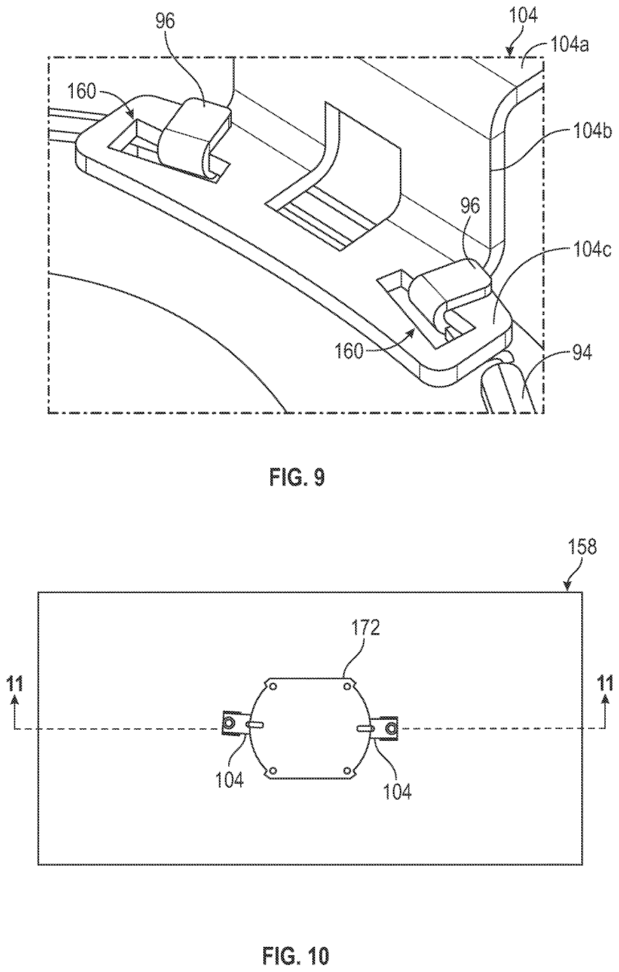

Turning to FIGS. 8-9, the support brackets 104 are shown mounted to the cage 102 at the first side 130 thereof. The support brackets 104 may be selectively positioned around the cage 102 via the mounting flanges 94 to mount the drop-in firestop device 100 to a concrete structure 158 as shown in FIG. 10. In certain examples, the drop-in firestop device 100 may be used with a cross-laminated timber (CLT) deck or other similarly approved material for floor assembly.

The term “concrete structure” is used herein to generally refer to any various types of concrete structures, including, but not limited to, floors, decks, walls, slabs, inclined slabs, etc. The “cylindrical” passages or holes also include variations on the desired circular cross-section such as oval or multi-lobed cross-sections that are usually within an inch of a desired circular section.

The support brackets 104 may have a stepped configuration. The support brackets 104 may each include a first extension member 104a and a second extension member 104c that are connected by a vertical step 104b. The first extension member 104a may be integrally connected at an upper portion of the vertical step 104b and the second extension member 104c may be integrally connected at a lower portion of the vertical step 104b. The first and second extension members 104a, 104c may be generally perpendicular relative to the vertical step 104b. The support brackets 104 may be made from sheet metal, for example, stainless steel, aluminum, or an alloy of these metals. In other examples, the support brackets 104 may be L-shaped.

The first extension member 104a of the support brackets 104 may extend above the first side 130 of the cage 102 a distance X (see FIG. 2). In certain examples, the distance X is about 0.5 inches, although alternatives are possible. The total height H1 (see FIG. 2) of the drop-in firestop device 100 may be between about 5 inches to about 6 inches.

The second extension member 104c may define at least two projection openings 160 for receiving respective projections 96 of the plurality of mounting flanges 94 located at the first side 130 of the cage 102. The support brackets 104 can be selectively located about the cage 102 to receive respective ones of the projections 96 of the plurality of mounting flanges 94 as required to fit within dimensional constraints of a particular application for final assembly. When the support brackets 104 are mounted to the cage 102 at the first end 130 thereof, the projections 96 extend through the projection openings 160 of the support brackets 104. The projections 96 may be bent to create a flange over a portion of the second extension member 104c to secure the support brackets 104 in a locked position on the cage 102. Such a construction prevents inadvertent removal of the support brackets 104 from the cage 102.

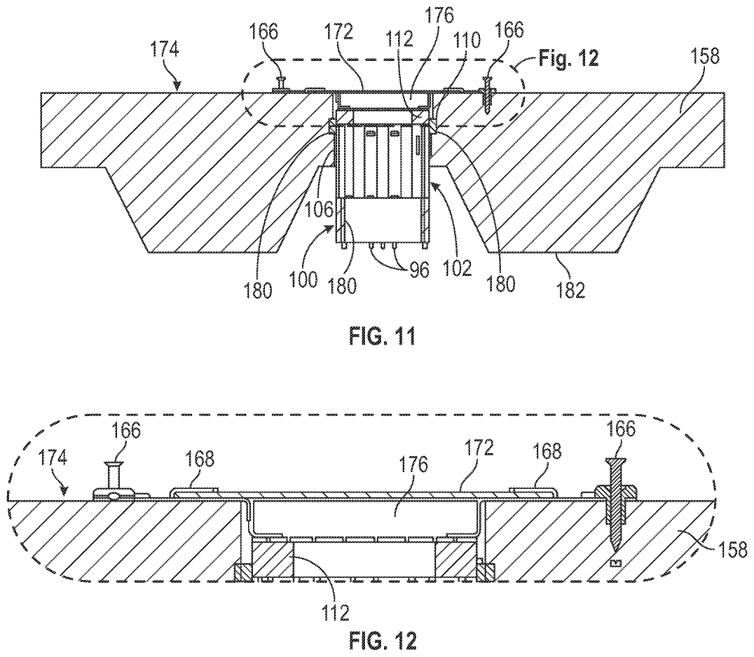

The first extension member 104a of the support brackets 104 each define an opening 162 at a distal end 164 thereof. The opening 162 is configured to receive a concrete fastener 166 (see FIGS. 11-12) for mounting the support brackets 104 at the top side 130 of the concrete structure 158.

Referring again to FIG. 8, the first extension members 104a of the support brackets 104 may each include a tab member 168 stamped from a cutout 170 in the first extension member 104a. The tab members 168 can be used to secure a safety cap 172 (see FIG. 12) to a top side 174 of the concrete structure 158. The safety cap 172 can be secured to the concrete structure 158 by bending the tab members 168 of the support brackets 104 down over the safety cap 172. The safety cap 172 can be designed to support loads as required by OSHA.

FIGS. 11-12 show the drop-in firestop device 100 installed in a preexisting, hollow sleeved, or core-drilled cylindrical passage or hole 176 through the concrete structure 158 in accordance with the principles of the present disclosure. The drop-in firestop device 100 may be inserted into the hole 176 from the top side 174 of the concrete structure 158. Typically, the hole 176 is bored or drilled after the concrete structure 158 has hardened, or is a pre-existing hole. The diameter of the hole 176 may vary with the diameter of the drill or boring tool.

In certain examples, the cage 102 can be positioned to collapse around a tube, pipe, or conduit prior to the drop-in firestop device 100 being fitted from above into the hole 176. That is, the drop-in firestop device 100 may be wrapped about a pipe 178 (e.g., tube, conduit, cable, wires, or other elongated members) (see FIG. 14) prior to installation. In certain examples, the cage 102 may also be placed inside the hole 176 prior to installation of a tube, pipe, or conduit. As such, once the drop-in firestop device 100 is ready to be installed, the cage 102 of the drop-in firestop device 100 may either be collapsed about the pipe 178 and then pushed into the hole 176 of the concrete structure 158 or the cage 102 of the drop-in firestop device 100 may be pushed into the hole 176 of the concrete structure 158 before a tube, pipe, or conduit is installed.

The drop-in firestop device 100 may be configured to fit a range of different diameters of tubes, pipes, or conduits with the penetrating pipe diameters typically differing by one quarter to two inches in diameter for passages from about 3 to about 8 inches in diameter, with larger ranges as the pipe diameter increases. For example, the cage 102 can have a diameter of about 4.5 inches. It will be appreciated that the cage 102 may be sized to fit a variety of different sized pipes. In certain examples, the cage 102 may be configured to fit a nominal pipe size of 2 inches, 2.5 inches, 3 inches, 4 inches or 6 inches. In certain examples, the cage 102 may also be sized to fit within a hole that has a diameter that ranges from about 3 inches to about 8 inches in a concrete structure.

When the drop-in firestop device 100 is placed in the hole 176 of the concrete structure 158 as depicted in FIG. 11, the first smoke-seal ring 110 will be positioned between sidewalls 180 of the hole 176 and the cage 102 to seal against an inner diameter of the hole 176. In certain examples, the concrete structure 158 may be a concrete floor or concrete deck that has a corrugated bottom plate 182 on a lower side or bottom side thereof to act as a concrete form when the concrete is poured. The corrugated bottom plate 182 may also be referred to as a concrete pan or corrugated metal concrete form.

During use, the first smoke-seal ring 110 can help to prevent smoke/gas from passing through the periphery of the hole 176 in the concrete structure 158. A diameter of the cage 102 may be about ¼ an inch smaller than a diameter of the hole 176. The first smoke-seal ring 110 may be about ¼ inches thick to form an interference fit with the expected diameter or cylindrical shape of the hole 176 of the concrete structure 158. In one example, the first smoke-seal ring 110 may be configured to resiliently engage the hole 176 that has a diameter from about 3 inches to about 8 inches, although alternatives are possible.

The first intumescent ring 106 may be 2 mm thick and functions to expand when exposed to a fire to seal against an inner diameter of the hole 176. That is, when the temperature rises, the first intumescent ring 106 will heat up, expand, and char when exposed to flames. When the first intumescent ring 106 becomes hot enough, it will quickly expand to multiple times its original volume.

The first intumescent ring 106 may activate and begin to expand at approximately 375° F. to prevent the spread of flame/smoke/gases around the periphery of the hole 176 in the concrete structure 158. The first intumescent ring 106 may extend above the sidewall 180 of the hole 176 and the cage 102 to expand both outward and upward along the longitudinal axis 128 to provide a seal against the hole 176 to prevent smoke and fire from passing upward through an annular gap between the cage 102 and the hole 176. This expansion will help to create a barrier, or seal, substantially preventing fire, heat, and smoke from moving from one area of a building to another for at least some period of time.

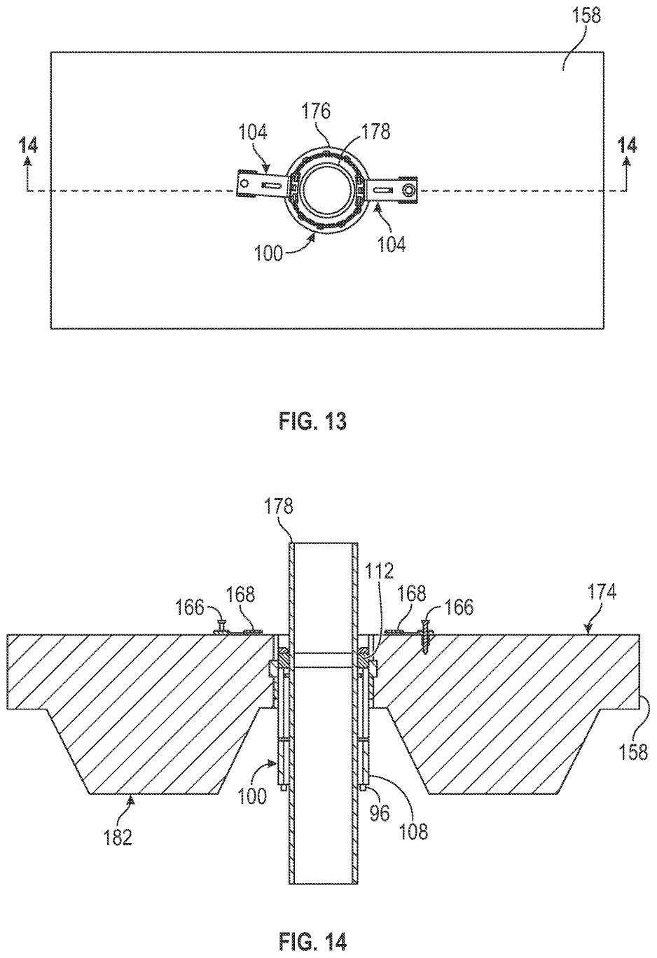

Turning to FIGS. 13-14, the second smoke-seal ring 112 is designed to seal against an outer diameter of the pipe 178 placed within the hole 176 of the concrete structure 158. The pipe 178 may pass through the center opening of the second smoke-seal ring 112, the second intumescent ring 108, and the cage 102.

The second smoke-seal ring 112 prevents smoke/gas from exiting around the periphery of the pipe 178. The second smoke-seal ring 112 may be have an inner diameter sized to engage the outer portion or outer diameter of the pipe 178 passing through the hole 176 so as to provide a seal to prevent passage of smoke/gas. The pipe 178 may be a two-inch schedule 40 pipe, although alternatives are possible. In other examples, the second smoke-seal ring 112 may be about 1 inch thick suitable for pipes about 4-6 inches in diameter, although alternatives are possible.

The second intumescent ring 108 activates and begins to expand at approximately 375° F. to prevent spread of flame/gas around the pipe 178 to seal against an outer diameter of the pipe 178. As the second intumescent ring 108 is heated and expands, the cage 102 helps to prevent the second intumescent ring 108 from expanding outward so the expansion of the second intumescent ring 108 is directed to expand inward and press against the pipe 178. The second intumescent ring 108 can include a select number of lengths to compress the pipe 178 and seal the entire hole 176 to prevent smoke/gas and fire from passing upward through the annular gap between the cage 102 and the hole 176.

Another aspect of the present disclosure relates to a method 200 of making a firestop device. The firestop device may be as described above. In this example, the method 200 includes operations 202, 204, 206, and 208.

The operation 202 is performed to provide a sheet metal structure of a desired size. The sheet metal structure can include a first part and a second part that are both movable between an opened position and a closed position. The sheet metal structure can have an inner surface 114 and an outer surface 116. The sheet metal structure can have a plurality of ring locating tabs 136.

The operation 204 is performed when the sheet metal structure is in the closed position, securing a first intumescent ring 106 and a first smoke-seal ring 110 and to the outer surface 116 of the sheet metal.

The operation 206 is performed when the sheet metal structure is in the opened position, securing a second intumescent ring 108 and a second smoke-seal ring 112 to the inner surface 114 of the sheet metal.

The operation 208 is performed to retain the first and second smoke rings 110, 112, and the first and second intumescent rings 106, 108, to the respective inner and outer surfaces 114, 116 of the sheet metal structure with the plurality of ring locating tabs 136.

Another aspect of the present disclosure relates to a method 300 of installing the firestop device 100 described above. In this example, the method 300 includes operations 302, 304, 306, and 308.

The operation 302 is performed to provide a metal cage 102. The metal cage 102 can have a first smoke-seal ring 110 positioned on an outer surface 116 thereof and a first intumescent ring 106 positioned below the first smoke-seal ring 110 on the outer surface 116. The metal cage 102 can have a second smoke-seal ring 112 positioned on an inner surface 114 of the metal cage 102, and a second intumescent ring 108 positioned below the second smoke-seal ring 112 on the inner surface 114.

The operation 304 is performed to move the metal cage from an opened position to a closed position.

The operation 306 is performed to position the metal cage 100 into a passage 176 formed in or drilled through a concrete structure.

The operation 308 is performed to rigidly fix the metal cage 102 to the concrete structure.

In certain examples, the metal cage 102 is inserted from a top side 174 of the concrete structure and rigidly fixed with support brackets 104. In other examples, the metal cage is inserted from a bottom side of the concrete structure and rigidly fixed with wing plates.

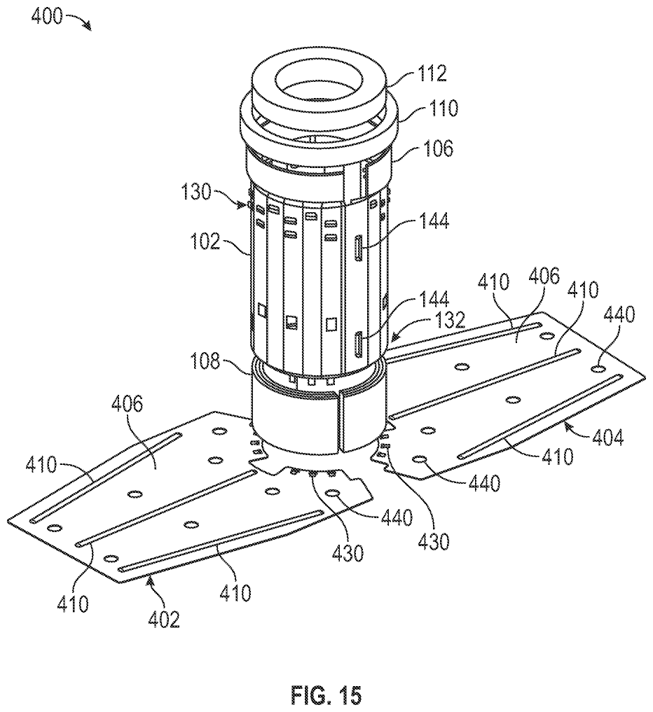

Turning to FIG. 15, an exploded perspective view of another firestop device is depicted in accordance with the principles of the present disclosure. The firestop device depicted is an under-deck firestop device 400 designed for installation from a bottom side of a concrete deck.

As shown, the under-deck firestop device 400 includes the cage 102 described above. For the sake of brevity, only those portions of the under-deck firestop device 400 that differ from the drop-in firestop device 100 illustrated in FIGS. 1-14 discussed above will be described in detail. Thus, similar components of the under-deck firestop device 400 that correspond to the respective components of the drop-in firestop device 100 will not be explained in detail again.

The under-deck firestop device 400 includes a set of identical first and second wing plates 402, 404 configured to be attached at the second side 132 of the cage 102.

The first and second wing plates 402, 404 may be stamped from sheet metal, for example, stainless steel, aluminum, or an alloy of these metals. The first and second wing plates 402, 404 can be individually attached to the cage 102 at the second side 132 thereof to form a circular opening thereabout, as will be described below.

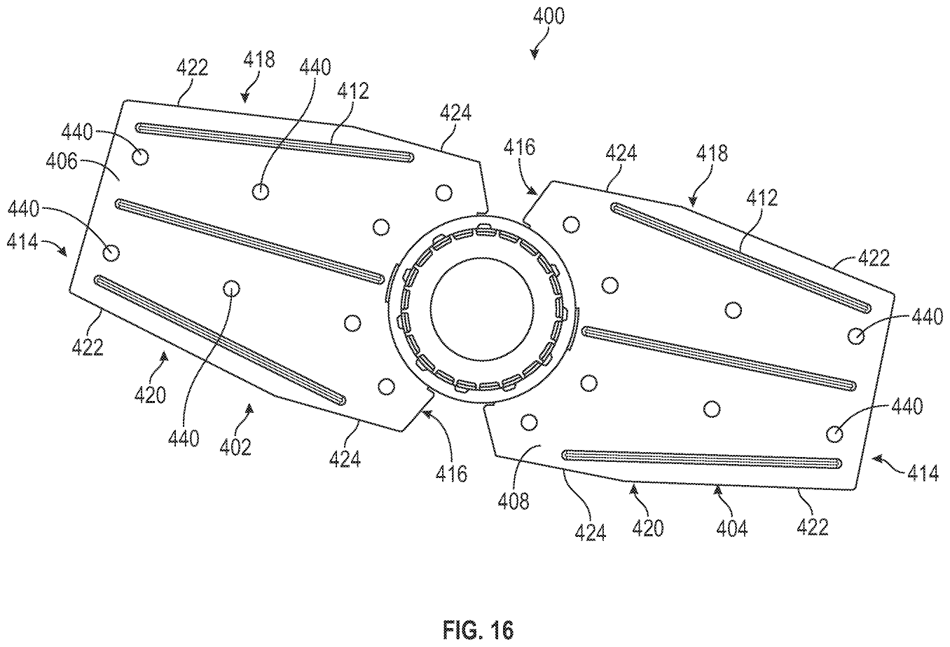

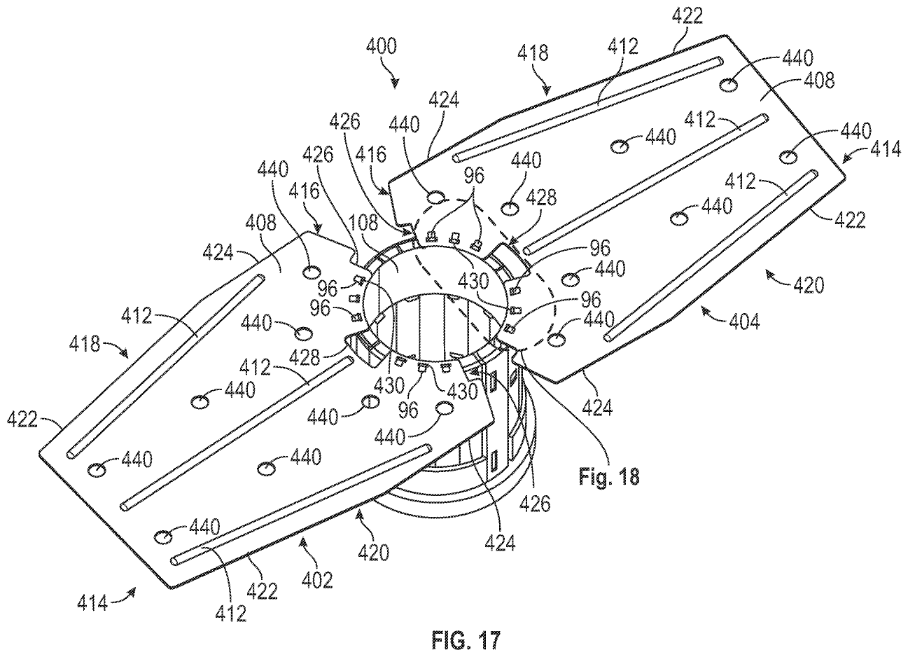

Referring to FIGS. 16-17, the first and second wing plates 402, 404 are shown attached to the cage 102 at the second side 132. Because the first and second wing plates 402, 404 are identical, only the first wing plate 402 will be described in detail. It will be appreciated that the features described herein with reference to the first wing plate 402 will also apply to the second wing plate 404.

The first wing plate 402 has a top surface 406 (see FIG. 15) and an opposite bottom surface 408 (see FIG. 17). In certain examples, the first wing plate 402 may be define a plurality of grooves 410 in the top surface 406 thereby making corresponding ribs 412 that protrude at the bottom surface 408 of the first wing plate 402. When the first wing plate 402 is attached to the cage 102, the ribs 412 can be stiffening ribs designed to strengthen the first wing plate 402. In the example depicted, the first wing plate 402 includes three ribs 412, although alternatives are possible.

The first wing plate 402 has a distal end 414 and a proximal end 416. The proximal end 416 of the first wing plate 402 is designed to be mounted to the cage 102. The first wing plate 402 also has first and second opposing sides 418, 420 that extend between the first and second ends 414, 416.

The first wing plate 402 can be attached at the second side 132 of the cage 102. In certain examples, the first wing plate 402 may be wider at the proximal end 416 and narrower at the distal end 414. That is, the first and second opposing sides 418, 420 can each have tapered portions 422 that taper outwardly from the distal end 414 toward straightened portions 424 at the proximal end 416.

Still referring to FIG. 17, the proximal end 416 of the first wing plate 402 also includes two tab members 426 that together define a recess 428 therebetween. The two tab members 426 define locking holes 430 for receiving respective ones of the projections 96 of the plurality of mounting flanges 94 located at the second side 132 of the cage 102. That is, the first wing plate 402 can be selectively attached about the cage 102 to receive the projections 96 of the plurality of mounting flanges 94. In the example depicted, the two tab members 426 of the first wing plate 402 includes three locking holes 430, although alternatives are possible.

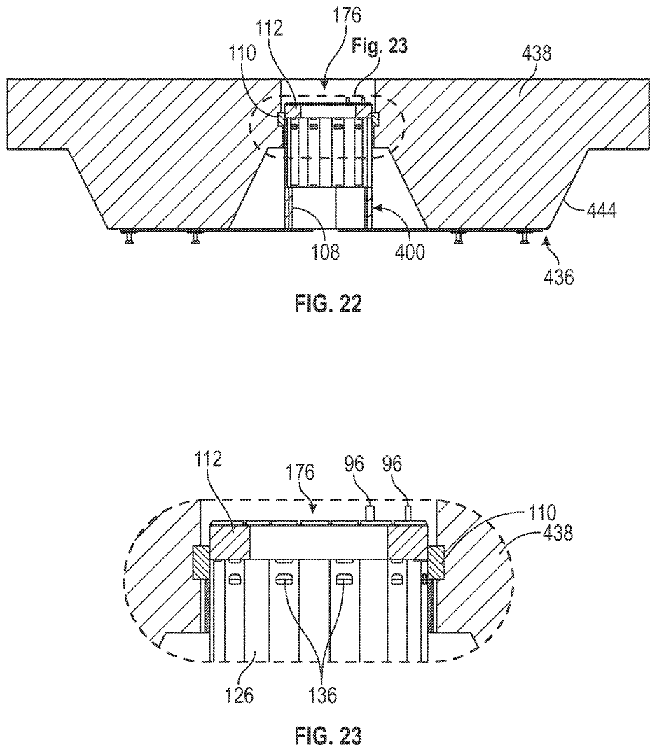

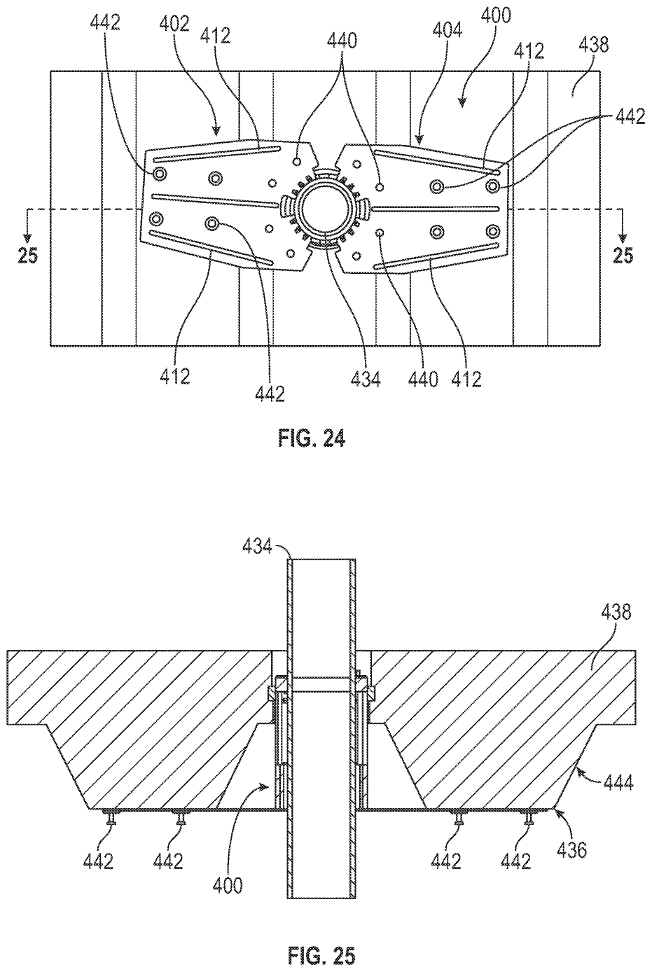

The two tab member 426 of the first wing plate 402 may include a concave edge 432 to interface circumferentially with an outer surface of a pipe, tube, or conduit 434 (see FIGS. 24-25) when installed. As noted above, the pipe 434 may be a 2 inch, 3 inch or 4 inch nominal pipe intended for installation in existing or core-drilled holes 176 from a bottom side 436 (see FIG. 22) of a concrete deck 438 (see FIGS. 22-23). For example, the under-deck firestop device 400 may be collapsed around the pipe 434 prior to being placed in the hole 176 of the concrete deck 438 from the bottom side 436 thereof. In other examples, the under-deck firestop device 400 may be placed in the hole 176 without the pipe 434, which may be installed at a later date.

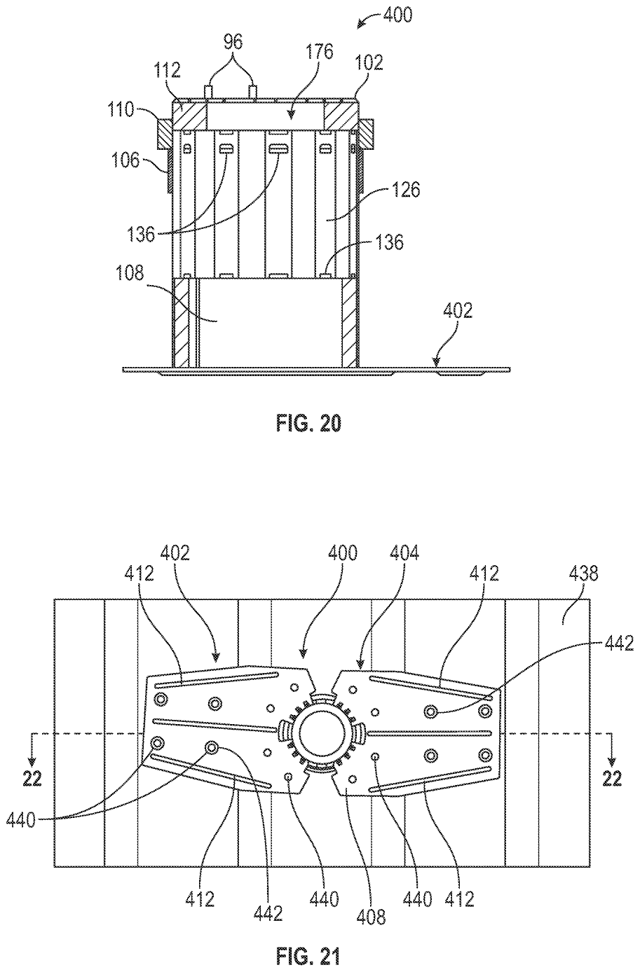

A bottom perspective view of the under-deck firestop device 400 is depicted. The first wing plate 402 also defines a plurality of fastener holes 440 through which a shaft of a fastener passes when mounting the under-deck firestop device 400 to a concrete deck. FIGS. 19-21 show the first and second wing plates 402, 404 attached at the second side 132 of the cage 102. The first and second wing plates 402, 404 can each be independently attached to the cage 102 when the cage 102 is in the closed position. Together the first and second wing plates 402, 404 form a circular opening about the cage 102. The first and second wing plates 402, 404 can be attached opposite one another at fixed locations around the cage 102 via the two tab members 426.

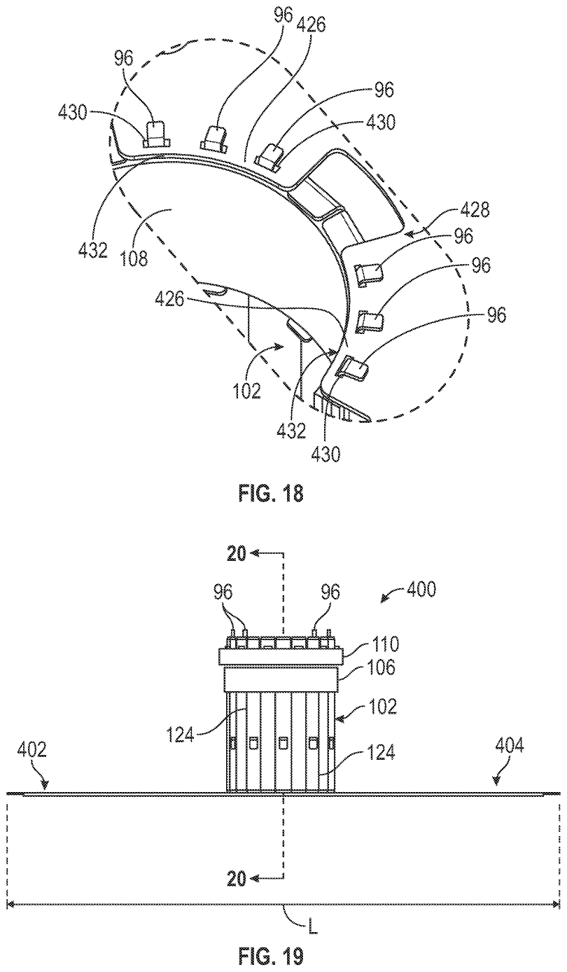

FIG. 18 shows the second wing plate 404 attached to the cage 102 with the projections 96 of the mounting flanges 94 received within the openings 430 of the tab members 426 of the second wing plate 404. That is, when the second wing plate 404 is attached to the cage 102, the projections 96 may extend through the openings 430 of the tab members 426. To secure the second wing plate 404 to the cage 102, the projections 96 may be bent once received in the openings 430 to extend over the tab members 426. Such a construction prevents inadvertent removal of the second wing plate 404 from the cage 102.

FIGS. 21 and 24 are top views of the under-deck firestop device 400. The first and second wing plates 402, 404 together can form a diameter about the cage 102 that ranges from about 4 inches to about 6 inches, although alternatives are possible. When the first and second wing plates 402, 404 are attached at the second end 132 of the cage 102, they measure a total length span L (see FIG. 19) from the distal ends 414 thereof. The length L can be from 10 to 20 inches, although alternatives are possible. In certain examples, the length L can be less than 20 inches. In certain examples, the length L is about 16 inches.

FIGS. 22-23 depict the under-deck firestop device 400 mounted to the concrete structure 438 and FIGS. 24-25 show the under-deck firestop device 400 with the pipe 434 installed.

The first and second wing plates 402, 404 of the under-deck firestop device 400 can be secured to the bottom side 436 of the concrete deck 438 via concrete fasteners 442. That is, the concrete fasteners 442 may pass through the fastener holes 440 defined in the first and second wing plates 402, 404 and into the concrete deck 438 to fasten the first and second wing plates 402, 404 thereto.

In certain examples, the concrete fasteners 442 may also pass through a corrugated bottom plate 444 of the concrete deck 438 to fasten both the first and second wing plates 402, 404 thereto. Accordingly, the fastener holes 440 and concrete fasteners 442 may align with the concrete for rigidly attaching the under-deck firestop device 400 thereto.

### Example Aspects of the Disclosure

Aspect 1. A firestop device comprising:
a sleeve structure having a first part and a second part connected at a joint section, the first and second parts being movable between an opened position and a second position, the sleeve structure having an inner surface and an opposite outer surface;
a first smoke-seal ring positioned on the outer surface of the sleeve structure;
a first intumescent ring positioned below the first smoke-seal ring on the outer surface of the sleeve structure;
a second smoke-seal ring positioned on the inner surface of the sleeve structure; and
a second intumescent ring positioned below the second smoke-seal ring on the inner surface of the sleeve structure.

Aspect 2. The firestop device of aspect 1, wherein, when in the closed position, the sleeve structure has a first end, an opposite second end, and a longitudinal axis extending between the first and second ends.

Aspect 3. The firestop device of aspect 2, wherein the first and second ends of the sleeve structure include mounting flanges with projections.

Aspect 4. The firestop device of aspect 3, further comprising support brackets configured to be attached to the first end of the sleeve structure via the mounting flanges to mount the firestop device to a top side of a concrete structure.

Aspect 5. The firestop device of aspect 4, wherein the concrete structure is a corrugated concrete deck.

Aspect 6. The firestop device of aspect 4, wherein the concrete structure is a flat concrete deck.

Aspect 7. The firestop device of aspect 3, further comprising wing plates configured to be attached to the second end of the sleeve structure via the mounting flanges to mount the firestop device to a bottom side of a concrete structure.

Aspect 8. The firestop device of aspect 1, further comprising a latch arrangement to lock the sleeve structure in the closed position.

Aspect 9. The firestop device of aspect 8, wherein the latch arrangement includes a tab member and a tab receptacle for receiving the tab member.

Aspect 10. The firestop device of aspect 1, wherein the sleeve structure includes a plurality of ring locating tabs.

Aspect 11. The firestop device of aspect 10, wherein the first and second smoke-seal rings and the first and second intumescent rings are respectively adhered or otherwise secured to the inner and outer surfaces of the sleeve structure by the plurality of ring locating tabs.

Aspect 12. The firestop device of aspect 10, wherein the plurality of ring locating tabs are unitary with the sleeve structure.

Aspect 13. The firestop device of aspect 10, wherein the plurality of ring locating tabs are stamped into the sleeve structure.

Aspect 14. The firestop device of aspect 10, wherein the sleeve structure includes elongated segments each separated by score lines to allow the sleeve structure to be movable between the opened and closed positions.

Aspect 15. The firestop device of aspect 14, wherein the plurality of ring locating tabs are defined in the segments of the sleeve structure.

Aspect 16. A method of making a firestop device, the method comprising:
providing a sheet metal structure, the sheet metal structure including a first part and a second part, the first and second parts being movable between an opened position and a closed position, the sheet metal structure having an inner surface and an outer surface, the sheet metal structure having a plurality of ring locating tabs;
when in the closed position, securing a first smoke-seal ring and a first intumescent ring to the outer surface of the sheet metal structure;
when in the opened position, securing a second smoke-seal ring and a second intumescent ring to the inner surface of the sheet metal structure; and
retaining the first and second smoke-seal rings and the first and second intumescent rings to the respective inner and outer surfaces of the sheet metal structure with the plurality of ring locating tabs.

Aspect 17. The method of aspect 16, wherein the first and second parts are connected via a central joint segment in the sheet metal structure.

Aspect 18. The method of aspect 16, further comprising locking the sheet metal structure in the closed position using a latch arrangement.

Aspect 19. The method of aspect 18, wherein the latch arrangement is integrally formed with the sheet metal structure.

Aspect 20. A method of installing a firestop device, comprising:
providing a metal cage, the metal cage having a first smoke-seal ring positioned on an outer surface thereof, a first intumescent ring positioned below the first smoke-seal ring on the outer surface, a second smoke-seal ring positioned on an inner surface of the metal cage, and a second intumescent ring positioned below the second smoke-seal ring on the inner surface;
moving the metal cage from an opened position to a closed position;
positioning the metal cage into a passage formed or drilled into a concrete structure; and
rigidly fixing the metal cage to the concrete structure.

Aspect 21. The method of aspect 20, wherein the metal cage is inserted from a top side of the concrete structure and rigidly fixed with support brackets.

Aspect 22. The method of aspect 20, wherein the metal cage is inserted from a bottom side of the concrete structure and rigidly fixed with wing plates.

The principles, techniques, and features described herein can be applied in a variety of systems, and there is no requirement that all of the advantageous features identified be incorporated in a device, system or component to obtain some benefit according to the present disclosure.

From the forgoing detailed description, it will be evident that modifications and variations can be made without departing from the spirit and scope of the disclosure.

What is claimed is:

1. A firestop device comprising:
a sleeve structure having a first part and a second part connected at a joint section, the first and second parts being movable between an opened position and a second position, the sleeve structure having an inner surface and an opposite outer surface;
a first smoke-seal ring positioned on the outer surface of the sleeve structure;
a first intumescent ring positioned below the first smoke-seal ring on the outer surface of the sleeve structure;
a second smoke-seal ring positioned on the inner surface of the sleeve structure; and
a second intumescent ring positioned below the second smoke-seal ring on the inner surface of the sleeve structure.

2. The firestop device of claim 1, wherein, when in the closed position, the sleeve structure has a first end, an opposite second end, and a longitudinal axis extending between the first and second ends.

3. The firestop device of claim 2, wherein the first and second ends of the sleeve structure include mounting flanges with projections.

4. The firestop device of claim 3, further comprising support brackets configured to be attached to the first end of the sleeve structure via the mounting flanges to mount the firestop device to a top side of a concrete structure.

5. The firestop device of claim 4, wherein the concrete structure is a corrugated concrete deck.

6. The firestop device of claim 4, wherein the concrete structure is a flat concrete deck.

7. The firestop device of claim 3, further comprising wing plates configured to be attached to the second end of the sleeve structure via the mounting flanges to mount the firestop device to a bottom side of a concrete structure.

8. The firestop device of claim 1, further comprising a latch arrangement to lock the sleeve structure in the closed position.

9. The firestop device of claim 8, wherein the latch arrangement includes a tab member and a tab receptacle for receiving the tab member.

10. The firestop device of claim 1, wherein the sleeve structure includes a plurality of ring locating tabs.

11. The firestop device of claim 10, wherein the first and second smoke-seal rings and the first and second intumescent rings are respectively adhered or otherwise secured to the inner and outer surfaces of the sleeve structure by the plurality of ring locating tabs.

12. The firestop device of claim 10, wherein the plurality of ring locating tabs are unitary with the sleeve structure.

13. The firestop device of claim 10, wherein the plurality of ring locating tabs are stamped into the sleeve structure.

14. The firestop device of claim 10, wherein the sleeve structure includes elongated segments each separated by score lines to allow the sleeve structure to be movable between the opened and closed positions.

15. The firestop device of claim 14, wherein the plurality of ring locating tabs are defined in the segments of the sleeve structure.

16. A method of making a firestop device, the method comprising:
providing a sheet metal structure, the sheet metal structure including a first part and a second part, the first and second parts being movable between an opened position and a closed position, the sheet metal structure having an inner surface and an outer surface, the sheet metal structure having a plurality of ring locating tabs;
when in the closed position, securing a first smoke-seal ring and a first intumescent ring to the outer surface of the sheet metal structure;
when in the opened position, securing a second smoke-seal ring and a second intumescent ring to the inner surface of the sheet metal structure; and
retaining the first and second smoke-seal rings and the first and second intumescent rings to the respective inner and outer surfaces of the sheet metal structure with the plurality of ring locating tabs.

17. The method of claim 16, wherein the first and second parts are connected via a central joint segment in the sheet metal structure.

18. The method of claim 16, further comprising locking the sheet metal structure in the closed position using a latch arrangement.

19. The method of claim 18, wherein the latch arrangement is integrally formed with the sheet metal structure.

20. A method of installing a firestop device, comprising:
providing a metal cage, the metal cage having a first smoke-seal ring positioned on an outer surface thereof, a first intumescent ring positioned below the first smoke-seal ring on the outer surface, a second smoke-seal ring positioned on an inner surface of the metal cage, and a second intumescent ring positioned below the second smoke-seal ring on the inner surface;
moving the metal cage from an opened position to a closed position;
positioning the metal cage into a passage formed or drilled into a concrete structure; and
rigidly fixing the metal cage to the concrete structure.

21. The method of claim 20, wherein the metal cage is inserted from a top side of the concrete structure and rigidly fixed with support brackets.

22. The method of claim 20, wherein the metal cage is inserted from a bottom side of the concrete structure and rigidly fixed with wing plates.
